(19) United States
(12) Patent Application Publication
(10) Pub. No.: US 2008/0291208 A1
(43) Pub. Date: Nov. 27, 2008

(54) METHOD AND SYSTEM FOR PROCESSING DATA VIA A 3D PIPELINE COUPLED TO A GENERIC VIDEO PROCESSING UNIT

(76) Inventor: Gary Keall, Leicestershire (GB)

Correspondence Address: MCANDREWS HELD & MALLOY, LTD, 500 WEST MADISON STREET, SUITE 3400, CHICAGO, IL, 60661, US

(21) Appl. No.: 12/110,083

(22) Filed: Apr. 25, 2008

Related U.S. Application Data
(60) Provisional application No. 60/939,900, filed on May 24, 2007.
(60) Provisional application No. 61/043,503, filed on Apr. 9, 2008.

(51) Int. Cl. G06T 1/20

(52) U.S. Cl. 345/506

(57) ABSTRACT

Methods and systems for coupling a 3D pipeline to a generic video processing unit (VPU) are disclosed. Aspects of one method may include concurrently accessing different portion of stored graphics data by the generic VPU and the 3D pipeline within a chip. The graphics data may be processed by the VPU and the 3D pipeline. The VPU may be able to perform, for example, vector processing and scalar processing. The vector processing may be performed on the graphics data by a plurality of pixel processors. The graphics data may be stored and/or accessed in a vector register file (VRF), which may comprise a plurality of banks. Graphics data may be stored as a plurality of vectors in each of the banks in the VRF. The graphics data may be stored and/or read a vector at a time by the VPU and the 3D pipeline. Each vector may comprise, for example, 512 bits.

### CROSS-REFERENCE TO RELATED APPLICATIONS/INCORPORATION BY REFERENCE

This application makes reference to, claims priority to, and claims benefit of U.S. Provisional Application Ser. No. 60/939,900, filed May 24, 2007.

This application makes reference to:

U.S. Provisional Patent Application Ser. No. 61/043,503, filed Apr. 9, 2008; U.S. patent application Ser. No. 11/933,851, filed Nov. 1, 2007; U.S. patent application Ser. No. 11/867,292, filed Oct. 4, 2007; U.S. patent application Ser. No. 11/939,956, filed Nov. 14, 2007; and U.S. patent application Ser. No. 11/940,788, filed Nov. 15, 2007.

Each of the above stated applications is hereby incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to processing signals for display. More specifically, certain embodiments of the invention relate to a method and system for processing data via a 3D pipeline coupled to a generic video processing unit.

### BACKGROUND OF THE INVENTION

Electronic devices have changed the way people live. For example, various electronic devices, including hand-held mobile devices, may allow a user to play video games. Processing graphics data, for example, for video games, may require extensive computations by one or more processors. An electronic device may utilize one or more specialized graphics processors and/or hardware accelerators for rendering graphics for display. However, this may result in additional components, increased power consumption, increased implementation complexity, increased electronic device real estate, and ultimately increase in the size and cost of the electronic device.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method for processing data via a 3D pipeline coupled to a generic video processing unit, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary electronic device, in accordance with an embodiment of the invention.

FIG. 2 is a block diagram of exemplary image processing blocks in a chip, in accordance with an embodiment of the invention.

FIG. 3 is an exemplary data flow diagram for graphics data processed by a generic video processing unit and a 3D pipeline, in accordance with an embodiment of the invention.

FIG. 4 is a block diagram illustrating exemplary pixel processing units and vector register files, in accordance with an embodiment of the invention.

FIG. 5 is an exemplary block diagram illustrating pixel processing, in accordance with an embodiment of the invention.

### DETAILED DESCRIPTION OF THE INVENTION

Certain embodiments of the invention may be found in a method and system for processing data via a 3D pipeline coupled to a generic video processing unit. Aspects of the invention may comprise concurrent access by the generic video processing unit and the 3D pipeline to different portions of stored graphics data within a chip. The different portions of the stored graphics data may then be individually processed by the generic video processing unit and the 3D pipeline. The generic video processing unit may perform, for example, vector processing and scalar processing. The vector processing may be performed on the stored graphics data by a plurality of pixel processors.

The stored graphics data may be stored and/or accessed in a vector register file, which may comprise a plurality of banks, for example, four banks. Graphics data may be stored as a plurality of vectors, for example, 64 vectors, in each of the four banks in the vector register file. The graphics data may be stored and/or read a vector at a time by the generic video processing unit and the 3D pipeline. Each vector may comprise, for example, 512 bits.

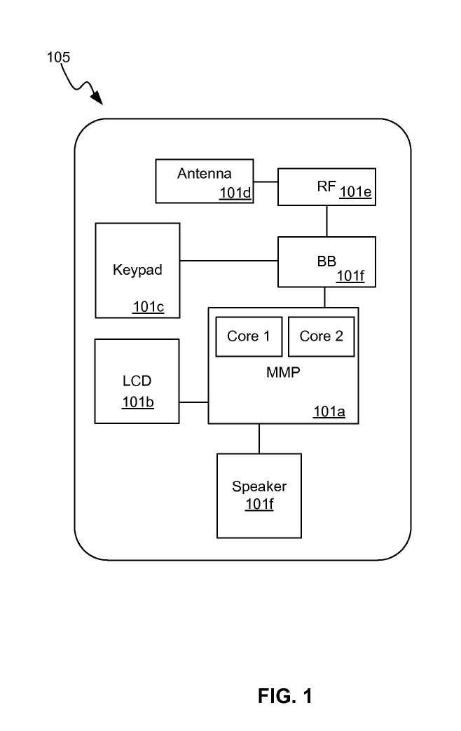

FIG. 1 is a block diagram of an exemplary electronic device, in accordance with an embodiment of the invention. Referring to FIG. 1, there is shown a mobile multimedia device 105 that comprises a mobile multimedia processor (MMP) 101a, an antenna 101d, a radio frequency (RF) block 101e, a baseband processing block 101f, an LCD display 101b, a keypad 101c, and a speaker 101f.

The MMP 101a may comprise suitable circuitry, logic, and/or code and may be adapted to perform video and/or multimedia processing for the mobile multimedia device 105. The MMP 101a may further comprise a plurality of processor cores, indicated in FIG. 1 by Core1 and Core2. The MMP 101a may also comprise integrated interfaces, which may be utilized to support one or more external devices (not shown) that may be coupled to the mobile multimedia device 105.

The mobile multimedia device 105 may process and communicate data via the antenna 101d, the RF block 101e, the baseband processing block 101f, and the MMP 101a. Processed audio data may be communicated to the audio block 101f and processed video data may be communicated to the LCD 101b. The keypad 101c may be utilized for communicating processing commands and/or other data for use of the mobile multimedia device 105. The mobile multimedia device 105 may be used, for example, to play video games where the user may play a game installed on the mobile multimedia device 105 or the user may play a internet game, for example. Playing a video game may require, for example, rendering 3D graphics.

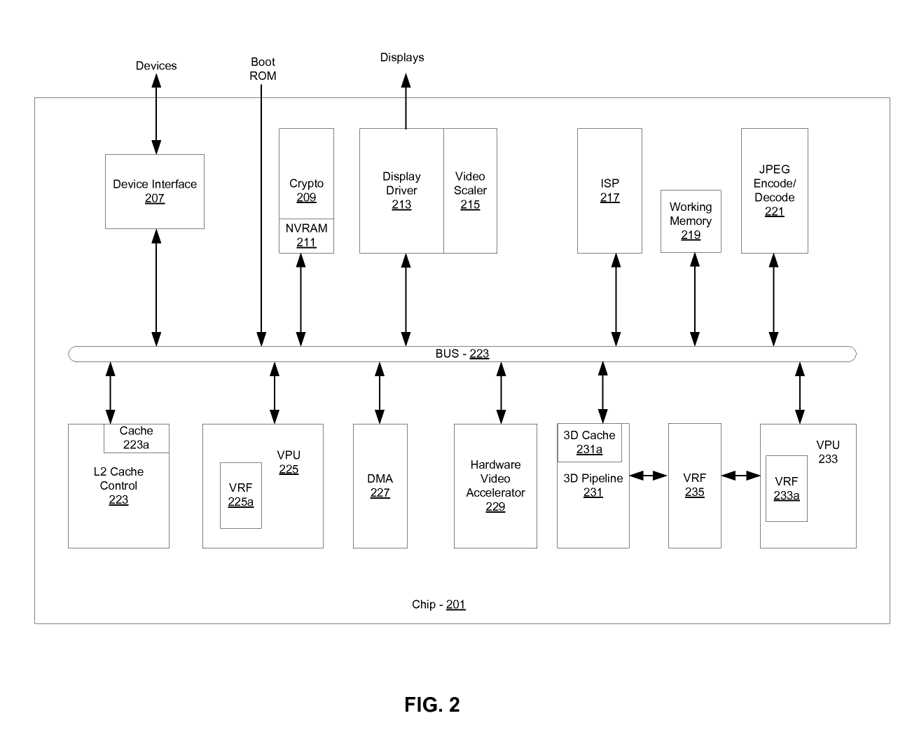

While an embodiment of the invention may have been described with respect to a mobile terminal, the invention need not be so limited. For example, various embodiments of the invention described with respect to FIG. 1, and with respect to FIGS. 2-5 below, may be used with other devices that process graphics data. Graphics data may comprise, for example, synthetically created and animated images. For example, an embodiment of the invention may be used with set-top boxes and various forms of PCs.

The separate cores of the MMP 101a may be integrated on a single chip, and may be located in separate regions of the chip, with devices that may be enabled for particular functions or processes. For example, a higher percentage of high threshold CMOS transistors may be located in one region for lower leakage current, and a higher percentage of lower threshold voltage CMOS transistors may reside in other regions, for higher speed applications. In this manner, speed and power usage may be tuned for particular applications or processes.

FIG. 2 is a block diagram of exemplary image processing blocks in a chip, in accordance with an embodiment of the invention. Referring to FIG. 2, there is shown a chip (integrated circuit) 201 comprising a bus 223 that may provide a channel for communication for the chip 201 and external devices. The bus 223 may comprise one or more busses to enable communication between peripherals, memory and L2 cache memory, for example.

The chip 201 may comprise a device interface 207, a crypto block 209, a NVRAM 211, a display driver 213, a L2 cache control block 223, a cache memory 223A, a video processing unit (VPU) 225 and a direct memory access (DMA) block 227. The chip 201 may also comprise a video scaler 215, an image sensor pipeline (ISP) 217, a memory 219, a JPEG encode/decode block 221, a hardware video accelerator (HVA) 229, a 3D pipeline 231 with a 3D cache memory 231a, a VPU 233 with a vector register file (VRF) 233a, and a VRF 235.

The device interface 207 may comprise suitable circuitry, logic and/or code that may enable interfacing external devices to chip 201. The external devices may comprise a host and/or double data rate (DDR) synchronous dynamic random access memory (SDRAM), for example. The device interface 207 may be communicatively coupled to the bus 223 to allow communication to other components in the chip 201.

The crypto block 209 may comprise suitable circuitry, logic and/or code that may enable encrypting and/or decrypting data in the chip 201. The crypto block 209 may be used, for example, in compliance with digital rights management. The keys for the encrypting/decrypting may be stored, for example, in the non-volatile random access memory (NVRAM) 211.

The display driver 213 may comprise suitable circuitry, logic and/or code that may enable communicating graphics data and/or video data to a display. Graphics data may comprise, for example, synthetically created and animated images. Video data may comprise, for example, recorded or live video from film, video tapes, TV, video cameras, etc. The display driver 213 may be communicatively coupled to the bus 223 for receiving signals to be communicated to a display. The video scaler 215 comprise suitable circuitry, logic and/or code that may enable composing various images for display by the display driver 213.

The L2 cache control block 223 may comprise suitable circuitry, logic and/or code that may enable control of the cache memory 223A. The cache memory may comprise high speed memory and may be utilized to store frequently used data for faster data accesses by the VPU 225 and/or the VPU 233.

The VPU 225 may comprise suitable circuitry, logic and/or code that may enable processing of data and the control of devices and peripherals communicatively coupled to the chip 201. The VPU 225 may comprise a general purpose processor, for example, that may be capable of performing control operations as well as image sensor processing and 3D pipeline processing. The VPU 225 may perform general data processing as well as, for example, vector processing.

The VPU 225 may perform other tasks when not working on 3D pipeline tasks for graphics data. For example, the VPU 225 may perform audio processing, video processing, and/or perform other general purpose software processing tasks. Accordingly, the VPU 225 may be a generic video processing unit. The VPU 225 may also comprise the VRF 225a, where the VRF 225a may be used as, for example, general purpose registers for vectors that the VPU 225 may process.

The DMA block 227 may comprise suitable circuitry, logic and/or code that may enable access to memory without utilizing the VPU 225. In this manner, the speed of the system may be increased by reducing the processor usage and increasing the speed of memory access.

The ISP 217 may comprise suitable circuitry, logic and/or code that may enable processing of image data. The ISP 217 may comprise hardware and/or software implementations of filtering, demosaic, lens shading correction, defective pixel correction, white balance, image compensation, Bayer interpolation, color transformation, and post filtering, for example. The ISP 217 may have direct access to the working memory 219, which may be utilized as a buffer in the image pipeline during processing.

The JPEG encode/decode block 221 may comprise suitable circuitry, logic and/or code that may enable encoding and/or decoding of JPEG images, which may then be stored and/or displayed.

The HVA 229 may comprise suitable circuitry, logic and/or code that may enable rendering, encoding and decoding of video using MPEG-4 or H.264, for example, faster than would be possible with a processor only.

The 3D pipeline 231 may comprise suitable circuitry, logic and/or code that may enable processing of 3D data. The processing may comprise vertex processing, rasterizing, early-Z culling, interpolation, texture lookups, pixel shading, depth test, stencil operations and color blend, for example. The 3D pipeline 231 may also comprise the 3D cache 231a, which may be utilized to store data temporarily during processing, instead of communicating data outside of the 3D pipeline hardware to other memory blocks.

The VPU 233 may be substantially similar to the VPU 225. Accordingly, the VPU 233 may also comprise the VRF 233a, where the VRF 233a may be used as, for example, general purpose registers for vectors that the VPU 233 may process. Each processor VPU 225 and VPU 233 may be capable of performing the same tasks, but may have different speed and power performance. For example, the VPU 225 may be always on, whereas the VPU 233 may only be switched on when needed, thus providing configurable speed and power usage in the chip 201. The VRF 235 may comprise suitable circuitry and/or logic that may enable storing of graphics data, where the graphics data may be accessible by the VPU 233 and the 3D pipeline 231.

In operation, the chip 201 may be utilized to receive graphics data and/or video data from external sources via the bus 223. The 3D pipeline 231 may be utilized to process 3D images for display via the display driver 213. The ISP 217 may be utilized to process image data for display via the display driver 213.

The 3D pipeline 231, the ISP 217, the VPU 233, and associated components may reside on a portion of the chip 201 that may be, for example, powered up as needed, such as for graphics processing. Functions performed by the VPU 233 when used with the 3D pipeline 231 may comprise pixel shading and/or vertex shading. Aspects of the invention may comprise generating parameters for coloring the pixels rather than just transforming the vertices into screen space. One aspect of transforming the vertices may comprise the transformation of all coordinates of the vertices. 3D rendering space may be made up of polygons, which are typically triangles. The triangle may be made from vertices in a real world 3D space and then transformed into screen space. The 3D pipeline hardware may then fill in the triangle and interpolate the various parameters from across the vertices to determine how to color individual pixels, for texturing and coloring. Thus, the process may comprise vertex transformations and vertex shading calculations. The 3D pipeline 231 and the VPU 233 may access and process graphics data that may be stored in the VRF 235.

The VPUs 225 and 233 may perform other tasks when not working on 3D pipeline tasks for graphics data. For example, the VPUs 225 and/or 233 may perform audio processing, video processing, and/or perform other general purpose software processing tasks. Since the VPUs 225 and 233 may comprise a general purpose processor, they may perform general software processing tasks. In an embodiment of the invention, the VPUs 225 and 233 may be located in separate partitions of the chip 201 so as to be configurable for optimization of processing speed versus power consumption. The VPUs 225 and 233 may dynamically handle the processing of tasks based on the level of tasks to be performed, what other activities are taking place, and the current processing load of each VPU 225 and 233.

Therefore, the VPUs 225 and/or 233 may be able to execute instructions for a plurality of operations, including for vertex and pixel shading, for an operating system, for an application software, such as, for example, a video game software, and for driver software for interfacing the video game software to 3D hardware. The VPUs 225 and/or 233 may be time-shared, for example, among the various tasks needed for an electronic device, such as, for example, the mobile multimedia device 105. Accordingly, the use of the VPUs 225 and 233 for graphics data processing as well as general purpose software processing may be a cost-effective and flexible use of resources on an electronic device, such as, for example, the mobile multimedia device 105.

Although am embodiment of the invention is described with two VPUs 225 and 233, the invention need not be so limited. Various embodiments of the invention may allow, for example, use of a single VPU, or more than two VPUs.

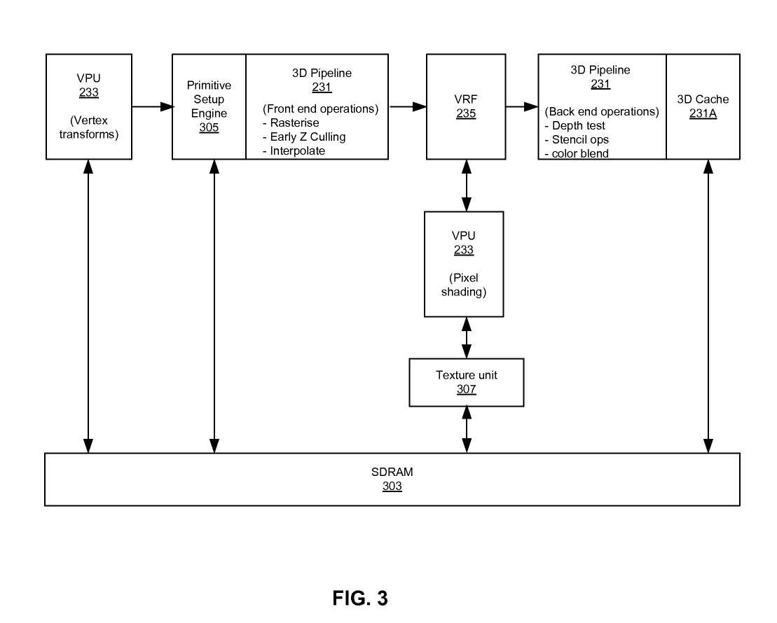

FIG. 3 is an exemplary data flow diagram for graphics data processed by a generic video processing unit and a 3D pipeline, in accordance with an embodiment of the invention. Referring to FIG. 3, there is shown the VPU 233, SDRAM 303, a primitive setup engine 305, the 3D pipeline 231 and associated 3D cache 231a, and a texture unit 307.

The SDRAM 303 may comprise suitable circuitry, logic and/or code that may enable the storage of data. The primitive setup engine 305 may comprise suitable circuitry, logic and/or code that may enable processing of primitive shapes such as triangles, for example, in the image data that in preparation for 3D processing by the 3D pipeline 231. A primitive shape may also be referred to as a “primitive.” A triangle may be a primitive with an index of three, and the triangle's parameters may comprise vertices, where the vertices may comprise coordinates. The texture unit 307 may comprise suitable circuitry, logic and/or code that may enable access to pixel textures stored in the SDRAM 303. The texture unit 307 may process texture data for pixel shading for pixels.

In operation, the VPU 233 may initiate the processing of graphics data. The VPU 233 may generate vertices that may correspond to the graphics images to be processed, and the generated vertices may be stored in the SDRAM 403. The address, or the index offset, for the vertices may then be communicated to the primitive setup engine 305 to establish primitive shapes. For a primitive with index three, the primitive set up engine 305 may process the triangle by, for example, determining parameters for the vertices, and making calculations to determine details between the vertices.

The parameters determined for a triangle by the primitive setup engine 305 may be communicated to the 3D pipeline 231, which may then start front-end processing of the triangle primitives. The front-end processing by the 3D pipeline 231 may comprise rasterizing primitives into pixels and interpolating pixel values from the vertices. The 3D pipeline 231 may also perform early Z culling, which may comprise determining whether a particular pixel may be visible in the final image. If a pixel is determined not to be visible in the final image, that pixel may be discarded to avoid processing and storing that pixel.

After the front-end operations by the 3D pipeline 231, the graphics data may be communicated by the 3D pipeline 231 to the VRF 235. The VPU 233 may read the graphics data from the VRF 235 in order for the VPU 233 to perform pixel shading upon the graphics data. The VPU 233 may utilize the texture unit 307 to look up texture information for various pixels, where the texture information may be stored, for example, in the SDRAM 303. Texture for a pixel may comprise, for example, chrominance and luminance information. Coordinates may be determined for each pixel that may need to have its texture determined, and the texture unit 307 may use the coordinates to read the corresponding textures. The texture unit 307 may also perform filtering on the textures based on textures of the neighboring pixels. The filtered textures may be communicated to the VPU 233.

The VPU 233 may then store the pixel shaded information in, for example, the VRF 235. The pixel information in the VRF 235 may then be accessible for further processing by the 3D pipeline 231. The 3D pipeline 231 may then perform back-end processing on the pixels in the VRF 235 that may have texture information. The back-end processing may comprise, for example, depth testing, stencil operations, and color blending. The results may be stored in the 3D cache 231a, and then in the SDRAM 303.

In an embodiment of the invention, the VPU 233 and the 3D pipeline 231 may comprise a fully programmable architecture with hardware segments incorporated for selected 3D pipeline processing. This may result in smaller chip sizes and higher power efficiency, since the VPU 233 may be utilized for other purposes when not doing 3D processing, or may be powered down completely with other components such as the 3D pipeline 231 and the VRF 235. Accordingly, the VPU 233 may be utilized for vertex shading and/or pixel shading, also execute 3D driver software, and then may be switched over to do audio or video processing.

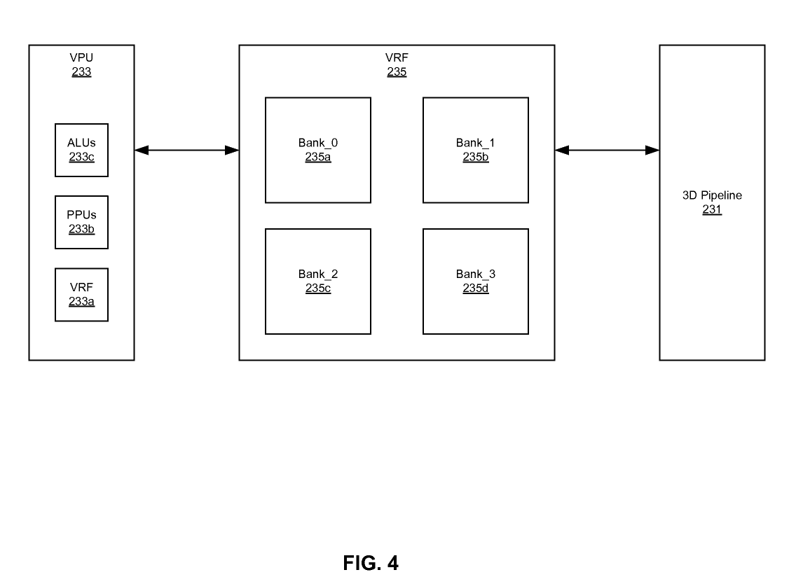

FIG. 4 is a block diagram illustrating exemplary pixel processing units and vector register files, in accordance with an embodiment of the invention. Referring to FIG. 4, there is shown the 3D pipeline 231, the VPU 233, and the VRF 235. The VPU 233 may comprise the VRF 233a, a plurality of pixel processing units (PPU) 233b, and one or more ALUs 233c. The VRF 235 may comprise a plurality of pixel banks Bank_0 235a, Bank1_235b, Bank_2 235c, and Bank_3 235d where pixel data may be stored.

The PPU 233b may comprise suitable logic, circuitry, and/or code that may enable vector processing. The PPU 233b may perform vector processing on pixel data stored in the VRF 235, for example. The ALUs 233c may comprise suitable logic, circuitry, and/or code that may enable scalar processing as a general purpose processor.

In operation, new pixel data may be written to one of the four pixel banks Bank_0 235a, Bank1_235b, Bank_2 235c, and Bank_3 235d by the VPU 233. This may allow, for example, the pixel data in the other three pixel banks to be processed by the 3D pipeline 231 and/or the PPU 233b. Similarly, when the 3D pipeline 231 is processing data in one of the pixel banks, the VPU 233 may process pixel data in the other three pixel banks. Accordingly, utilizing a plurality of pixel banks may minimize processing latency due to blocking.

For example, the VPU 233 may request pixel texturing from the texture unit 307, where the pixel data may be stored in the pixel bank Bank_0 235a. However, while waiting for the texture unit 307 to respond with appropriate texture information, the VPU 233 may process pixels in one of the other three banks, and the 3D pipeline 231 may process pixels in still another of the other three banks. By appropriately configuring operation of the VPU 233 and the 3D pipeline 231, processing delay due to blocking of data in the VRF 235 by another process may be reduced. Accordingly, a plurality of threads may be used for processing the pixel data in the four banks Bank_0 235a, Bank1_235b, Bank_2 235c, and Bank_3 235d.

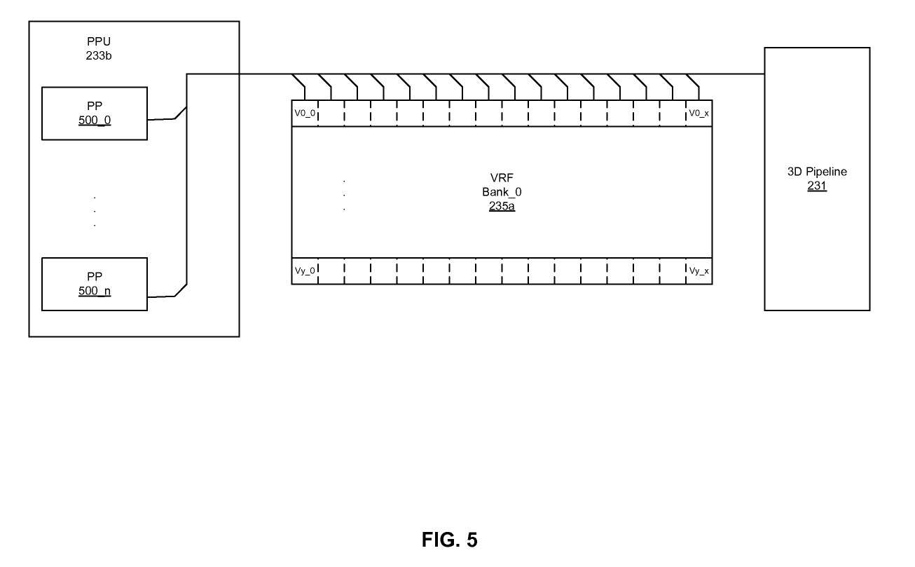

FIG. 5 is an exemplary block diagram illustrating pixel processing, in accordance with an embodiment of the invention. Referring to FIG. 5, there is shown the PPU 233b, the VRF Bank_0 235a, and the 3D pipeline 231. The plurality pixel processors (PPs) in the PPU 233b may be referred to as PP 500_0 . . . 500_x. The VRF Bank_0 235a may comprise, for example, 64 vectors V0 . . . V63, where each vector may comprise 16 32-bit elements V0_0 . . . V0_15. Each 32-bit element may be associated with a specific pixel. Accordingly, an embodiment of the invention may comprise 16 pixel processors (PPs) 500_0 . . . 500_15, where each PP may process an element in a vector. The 16 pixel processors (PPs) 500_0 . . . 500_15 may be able to concurrently (e.g., simultaneously) access pixel data in the VRF Bank_0 235a. Accordingly, the VPU 233 may interface with the VRF 235 via a 512-bit data bus. The 3D pipeline 231 may also be able to access, for example, an entire vector at once. Accordingly, if the vector comprises 16 32-bit elements, the 3D pipeline 231 may access the VRF via a 512-bit data bus.

Various embodiments of the invention may use different number of pixel processors and/or store pixels in a different format than shown with respect to the VRF Bank_0 235a. For example, each bank in the VRF 235 may comprise 64 vectors, where each vector may be viewed as 64 8-bit elements. Accordingly, the number of PPs in the PPU 233b may be increased, or each PP may handle multiple elements in a vector. Similarly, various embodiments of the invention may have different number of vectors, and/or different number of banks.

In accordance with an embodiment of the invention, aspects of an exemplary system may comprise, for example, one or more processors, such as, for example, the VPU 233 and a graphics processing hardware, such as, for example, the 3D pipeline 231, within the chip 201. The VPU 233 and the 3D pipeline 231 may be able to concurrently (e.g., simultaneously) access graphics data in different banks of the VRF 235. The VPU 233 and the 3D pipeline 231 may then individually process the different vectors. The VPU 233 and the 3D pipeline 231 may also store graphics data a vector at a time to different banks of the VRF 235. Accordingly, the VPU 233 may access graphics data in a bank of the VRF 235 while the 3D pipeline 231 is accessing graphics data in a different bank of the VRF 235. The VRF 235 may comprise a plurality of banks, for example, four banks. Each bank may comprise a plurality of vectors, for example, 64 vectors, and each vector may comprise, for example, 512 bits.

The VPU 233 may comprise, for example, the PPU 233b, which may process an entire vector. Each vector may comprise, for example, 16 elements of 32 bits per element. Accordingly, the PPU 233b may comprise 16 pixel processors (PPs) 500_0 . . . 500_15 for processing a vector. The VPU 233 may also comprise one or more ALUs 233c, which may perform scalar operations.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will comprise all embodiments falling within the scope of the appended claims.

What is claimed is:

1. A method for data processing, the method comprising:
concurrently accessing different portions of stored graphics data by a processor and graphics processing hardware, wherein said processor and said graphics processing hardware are integrated within a chip; and
individually processing said different portions of said stored graphics data, by said processor and said graphics processing hardware.

2. The method according to claim 1, wherein said stored graphics data is stored in a vector register file.

3. The method according to claim 2, comprising storing graphics data in one of a plurality of banks in said vector register file.

4. The method according to claim 3, comprising storing said graphics data as a plurality of vectors in each of said plurality of banks in said vector register file.

5. The method according to claim 4, wherein said stored graphics data is stored a vector at a time.

6. The method according to claim 4, wherein each of said plurality of vectors comprises 512 bits.

7. The method according to claim 4, wherein said processor accesses said stored graphics data a vector at a time.

8. The method according to claim 4, wherein said graphics processing hardware accesses said stored graphics data a vector at a time.

9. The method according to claim 1, comprising performing vector processing by said processor on said different portions of said stored graphics data.

10. The method according to claim 9, wherein said processor performs vector processing via a plurality of pixel processors.

11. The method according to claim 1, comprising performing scalar processing by a scalar processor within said processor.

12. The method according to claim 1, wherein said processor is a generic video processing unit.

13. The method according to claim 1, wherein said graphics processing hardware comprises a 3D pipeline.

14. A system for data processing, the system comprising:
one or more processors and graphics processing hardware that concurrently access different portions of stored graphics data, and that individually process said different portions of said stored graphics data.

15. The system according to claim 14, wherein said stored graphics data is stored in a vector register file.

16. The system according to claim 15, wherein said stored graphics data is stored in one of a plurality of banks in said vector register file.

17. The system according to claim 16, wherein said stored graphics data is stored as a plurality of vectors in each of said plurality of banks in said vector register file.

18. The system according to claim 17, wherein said stored graphics data is stored a vector at a time.

19. The system according to claim 17, wherein each of said plurality of vectors comprises 512 bits.

20. The system according to claim 17, wherein said one or more processors access said stored graphics data a vector at a time.

21. The system according to claim 17, wherein said graphics processing hardware accesses said stored graphics data a vector at a time.

22. The system according to claim 14, wherein said one or more processors perform vector processing on said different portions of said stored graphics data.

23. The system according to claim 22, wherein each of said one or more processors perform vector processing via a plurality of pixel processors.

24. The system according to claim 23, wherein each of said one or more processors comprises one or more scalar processors that perform scalar processing.

25. The system according to claim 14, wherein said processor is a generic video processing unit.

26. The system according to claim 14, wherein said graphics processing hardware comprises a 3D pipeline.

27. A system for data processing, the system comprising:
a video processing unit and a 3D pipeline within a chip that can concurrently access a vector register file to process graphics data;
wherein each of said video processing unit and said 3D pipeline stores graphics data a vector at a time;
wherein each of said video processing unit and said 3D pipeline reads graphics data a vector at a time; and
wherein said video processing unit comprises a plurality of pixel processors for processing said vector read from said vector register file.
